(19) United States
(12) Patent Application Publication
(10) Pub. No.: US 2009/0200773 A1
(43) Pub. Date: Aug. 13, 2009

(54) Wheeled apparatus for transporting loads

(75) Inventor: Martin Philip Riddiford, London (GB)

Correspondence Address: Breiner & Breiner, L.L.C., P.O. Box 320160, Alexandria, VA, 22320-0160, US

(73) Assignee: Fillaball Holdings Limited, Smarden (GB)

(21) Appl. No.: 12/320,877

(22) Filed: Feb. 6, 2009

Related U.S. Application Data
(60) Provisional application No. 61/064,253, filed on Feb. 25, 2008.

(30) Foreign Application Priority Data
Feb. 7, 2008 (GB) 0802312.9
Oct. 17, 2008 (GB) 0819092.8

(51) Int. Cl. B62B 1/00

(52) U.S. Cl. 280/651; 280/47.24

(57) ABSTRACT

Carts, trolleys or like load-carrying apparatus, for example a wheelbarrow, are disclosed. They incorporate two wheels (2, 3) which rotate about separate axes of rotation (4, 5) which are coplanar but inclined to one another, preferably at an angle (α) between 50° and 100°. They are mounted on a base structure or frame (1) in such a way that when the apparatus rests on horizontal ground, the plane containing the axes of rotation of the wheels (4, 5) may be moved to be vertical to allow the wheels to turn easily as the apparatus is moved along the ground, and moved away from vertical to cause the entire apparatus to be braked (as the wheels then try to travel in different directions across the ground). This principle may be applied to three and four-wheeled load-carrying apparatus.

### FIELD OF THE INVENTION

This invention relates to wheeled apparatus for transporting loads. It is applicable to such apparatus which is designed to carry a load placed on it, for example a cart, trolley or wheelbarrow, as well as to apparatus where there is some form of container which is fitted with wheels to assist in transporting the container, for example an article of luggage such as a suitcase or rucksack.

The terms “wheel” and “wheeled” used herein are intended to cover both standard wheels—usually discs with or without an outer peripheral cover or tire, and other rotatable members which function as wheels, for example hemispherical or spherical rollers.

### BACKGROUND TO THE INVENTION

Carts, trolleys and wheeled luggage are known in a very wide variety of shapes, sizes and designs. While in some cases it is possible to use just a single wheel, as in the case of a traditional wheelbarrow, for ease of operation and stability while moving, two or more wheels are usually employed. Even in the case of wheelbarrows and analogous load-carrying apparatus, suggestions have been made to use a pair of wheels in place of the customary single wheel, for example as disclosed in U.S. Pat. No. 1,572,531, U.S. Pat. No. 3,743,312 and U.S. Pat. No. 6,341,787.

Many carts, trolleys and wheeled luggage items use a pair of wheels which are designed to engage the ground and which are mounted on one or two axles. The arrangement is such that, on a horizontal support surface, the wheels are vertical and the axis of the axle or axles about which they rotate is horizontal. Examples of such constructions are disclosed in GB-A-138218 and US-A-2008/0174078, while FR-A-2610586 and U.S. Pat. No. 4,523,774 disclose trolleys where the wheels are generally spherical.

Arrangements are known in which the two wheels or two major wheels of certain wheeled load-supporting apparatus are slightly outwardly inclined. This is the case with certain designs of wheelchair and other mobility assistance devices, e.g. as disclosed in US-A-2008/0276977 and US-A-2004/0231613. FR-A-2823708 describes a luggage-carrying cart on to which, for example, a rucksack may be strapped and which is pulled by means of a harness attached to the user. As shown in FIG. 2 of the specification, the two wheels are slightly outwardly inclined, i.e. when the item is on flat ground, the tops of the wheels away from the ground are closer to one another than the ground-engaging bottoms of the wheels. Similar carts are disclosed in U.S. Pat. No. 6,260,864 and US-A-2003/0020250.

GB-A-651501 discloses a golf trolley for a golfer to carry his golf bag on and which has a pair of wheels which are likewise slightly splayed outwardly. US-A-2004/0026896 discloses a pushchair for a child where the front wheels are slightly splayed outwardly.

U.S. Pat. No. 4,252,334 discloses a wheelbarrow where the normal front wheel is replaced by a pair of outwardly inclined wheels to improve stability. U.S. Pat. No. 690,762 discloses a lawn sprinkler with a pair of spaced outwardly inclined wheels, likewise to improve stability (when the item is pulled along by the hose). This approach has also been used in castors, as disclosed in U.S. Pat. No. 4,457,045 and, with the two floor-engaging members at a more extreme angle, in U.S. Pat. No. 4,161,803.

Finally, GB-A-770602 discloses a truck or the like with a wheel arrangement using conical wheels located rotatably in bearing blocks, and with the edge of the cone contacting the ground.

### GENERAL DESCRIPTION OF THE INVENTION

I have now found that useful load-carrying apparatus may be constructed using at least two wheels or analogous rotatable ground-engaging members which engage the ground or other support surface on which the apparatus rests at spaced locations, and which rotate about axes inclined to one another, and wherein means are provided to enable the angle between the plane containing both axes to be varied relative to the plane of the surface on which the apparatus is supported. When the two planes are orthogonal, the wheels may rotate easily as the apparatus is moved along the surface, both pushing and pulling. As the angle between the planes decreases, the wheels exert a progressively increasing braking effect between the apparatus and the surface, which can be of particular value in certain applications.

In accordance generally with the present invention, there is provided load-carrying apparatus comprising a base structure carrying at least two, preferably a pair, of spaced apart rotatable ground-engaging members each mounted for rotation on the base structure, the axes of rotation of the respective rotatable members being coplanar but at an angle to one another of at least about 10°, and the arrangement being such that the angle between the plane of a surface on which the apparatus rests and the plane in which the axes of rotation extend may be varied. Preferably the axes of rotation intersect at a point above the surface on which the apparatus rests.

One way in which this may be achieved is by mounting the pair of rotatable ground-engaging members on the end of a frame which constitutes the base structure, with the plane containing the axes being at an angle to the direction in which of the frame extends away from the end carrying the rotatable members, the angle usually lying in the range of about 25-80°.

The apparatus may have just the two rotatable ground-engaging members or it may have more, in particular three or four.

By constructing a trolley, cart, wheelbarrow, piece of luggage or similar piece of apparatus in this way, the ease with which the apparatus may be rolled across a generally horizontal surface varies with the angle at which the frame of the item is held. The simplest case to consider is that of a two-wheeled luggage trolley having a frame with a pair of wheels mounted at one end and a pulling handle located at the other. When the handle is extended, and the user holds it at a convenient height, usually 50 to 100 cm above the (horizontal) ground, the plane containing the axes is arranged to be vertical, so when the apparatus is pulled along by the handle, the wheels turn without difficulty.

If the user raises or lowers his hand, the angle of the plane containing the wheel axes tilts, and progressively as the hand is raised or lowered further the wheels exert a braking effect. This is very easily felt by the person pulling the apparatus along, and this tactile feedback automatically prompts the user to adjust the angle for smooth running as the luggage trolley is pulled along. When, on the other hand, the user no longer wishes to pull it along, the handle is simply raised or lowered, so rotating the entire apparatus about a horizontal axis close to its base, so that it is either stood up with the handle extending substantially vertically, or laid down, for example to allow access to a side opening case mounted thereon, and with the handle resting on the ground. In either case, the plane containing the axes of rotation of the wheels is no longer vertical, and because the angle at which the wheels are mounted, movement of the trolley is essentially braked. This is achieved simply because the wheels would now try to travel along the ground, if rotated about their axes, in two directions at a substantial angle to one another and accordingly, with the handle up or down, the trolley will only move easily in rotation about a vertical axis. If an attempt is made to move it along the ground on which it rests, the wheels together exert a braking effect, and the trolley can only be forcibly dragged along.

As noted above, the present invention is characterised by having a pair of wheels mounted with their axes at an angle to one another and, furthermore, mounted so that the plane in which both the axes of rotation of the wheels lies can itself be rotated relative to the ground so that the wheels run smoothly or self-brake. Although this has obvious applications in the case of two-wheeled trolleys, carts, items of luggage and the like, as described above, the invention is not restricted to such apparatus containing only two wheels. One example of this is a conventional flatbed trolley, for example as used in transporting luggage in hotels or as a hand cart in a railway station or airport luggage-handling facility. If this is constructed with a pair of front wheels which are set non-coaxially, but on a framework which may be rotated about an axis parallel to the line joining the centres of rotation of the two wheels, then the trolley may be pulled along, but equally easily automatically braked in position during loading and unloading. The rear (or single wheel) of such a trolley may rotate conventionally about a horizontal axis, and may be castored if desired.

A further alternative construction is to mount three wheels, preferably equiangularly, on the end of an elongate arm or shaft, so that when that arm or shaft is held at an appropriate angle between horizontal and vertical, the plane containing the axes of rotation of the two wheels which are then lowermost, i.e. the ones engaging the ground, is vertical. This is of particular value in the construction of a shopping trolley which can be stood with the arm or shaft vertical for loading and unloading and, in that position, it is stable and braked, but then grasped easily and pulled along as desired once loaded. This is of particular value because the user does not have to twist the trolley about a vertical axis before starting; whichever two wheels are closest to the ground once the arm or shaft is moved from the top simply engage with the ground and, as the angle of the plane in which the axes of those two rotatable ground-engaging members lie comes to the vertical, the trolley may be rolled along.

The rotatable members are preferably ones having a fairly substantial ground-engaging surface, so that they do not dig into soft ground, mud or sand. A preferred construction is to make the members essentially hemispherical. Hemispherical wheels are known for use in vehicles designed to operate on snow, mud or sand, for example from GB-A-757663 and U.S. Pat. No. 2,967,581, where they are shown there mounted on axes inclined to one another, but there is no disclosure of mounting them in any way whereby the angle of the plane containing those axes can be varied relative to the plane of the ground on which the vehicle rests.

The rotatable members may be constructed of a fairly high friction material, for example rubber, or may be faced with such material; the greater the frictional properties, the more effective the braking action when the plane of the axles is not perpendicular to the ground on which the device sits. The frictional properties of the exterior surface of the rotatable members can vary, for example as between a relatively low friction area which contacts the ground when the apparatus is being wheeled along and relatively higher friction areas which contact the ground when the plane containing the axes of rotation is not vertical. Parts of the exterior of the rotatable members may be provided with a tread, analogous to the tread on a motor vehicle tire.

The exterior of the rotatable members may be rigid or yielding. In the latter case, by suitable construction of the exterior of the members, it is possible to provide a certain amount of “shock absorbing” properties to those members, which makes moving the apparatus across a rough hard surface, for example cobblestones, more comfortable. In particular, if the rotatable member has a raised resilient circular belt, which engages the ground when the plane containing the axes of rotation is vertical, this provides a resilience when the apparatus is moved, as well as widening the angular range within which the apparatus may comfortably be pulled along as the distance between the contact points with the ground widens slightly when the apparatus is loaded.

In this way, the rotatable members may impart a degree of suspension to the apparatus, cushioning the impact of rough terrain on the load carried by the apparatus. Additionally, or alternatively, the rotatable members may be mounted via a suspension system of known type.

If the rotatable members are hollow hemispherical ones, then the interior of the rotatable members may be used as a space for stowing part of the load. The rotatable members may be integrated into the overall designs so that their edge lies flush with the contour of a load-carrying chamber mounted on the frame.

Although the rotatable members may be supported on axles of any length, it is preferred to mount them on short stub axles fixed to either side of the frame so as to reduce the bending moment on each. Using hemispherical members, the stub axle is preferably substantially vertically above the ground-contacting part of the rotatable member.

A particularly preferred way of mounting the rotatable members is to provide in each a socket adapted to fit over a stub axle, the socket having a wear-resistant endpiece against which the tip of the axle bears in use. The socket may be lined with a self-lubricating inner sleeve, e.g. of oil-impregnated porous engineering plastics material, or be made of such material. Clip means may be provided to retain the stub axle in the socket. In this way, a very easy running, low friction mounting arrangement may be constructed without the use of, for example, a taper roller thrust bearing or like component.

The angle between the two axes about which the two rotatable members rotate is, as noted above, more than 10°. It is very convenient in design terms to make the angle between about 50° and about 100° which enables the rotatable members essentially to be placed one side of a load or load-carrying member such as a case or box. This lowers the centre of gravity of the loaded apparatus, leading to easier maneuverability.

Although in many load carrying apparatus of the type described above in accordance with the invention, the rotatable members are simply freely mounted for rotation about their axes when the apparatus is moved by hand, there is no reason, if circumstances warrant it, not to arrange motive power means associated with the rotatable members to provide a trolley, cart, barrow or the like which will then be driven to move under its own power. Means may be provided to apply drive to the rotatable members only when the apparatus or part thereof is at an appropriate inclination, i.e. with the plane containing the axes of the rotatable members substantially vertical.

### BRIEF DESCRIPTION OF THE DRAWINGS

The attached drawings show by way of example a number of ways in which the present invention may be put into effect. In the drawings:

FIGS. 1a, 1b and 1c show respectively diagrammatic side, end and perspective views of the underlying structure of a two-wheeled trolley apparatus according to the present invention;

FIG. 2 is a perspective drawing of a wheeled picnic hamper in accordance with the invention;

FIG. 3 is a backpack constructed in accordance with the invention;

FIG. 4 is a wheelbarrow constructed in accordance with the invention,

FIG. 5 is a shopping cart constructed in accordance with the invention,

FIG. 6 is a perspective view of a rotatable member suitable for use in apparatus according to the present invention;

FIG. 7 is a diagrammatic section of part of the rotatable member shown in FIG. 6;

FIG. 8 is an exploded view of the components shown in FIG. 7;

FIG. 9 is a diagram showing the configuration of the clip shown in FIG. 7, and

FIG. 10 is a wheeled luggage trolley for use in stations, hotels, factories and other locations, and constructed in accordance with the invention.

### SPECIFIC DESCRIPTION OF PREFERRED EMBODIMENTS

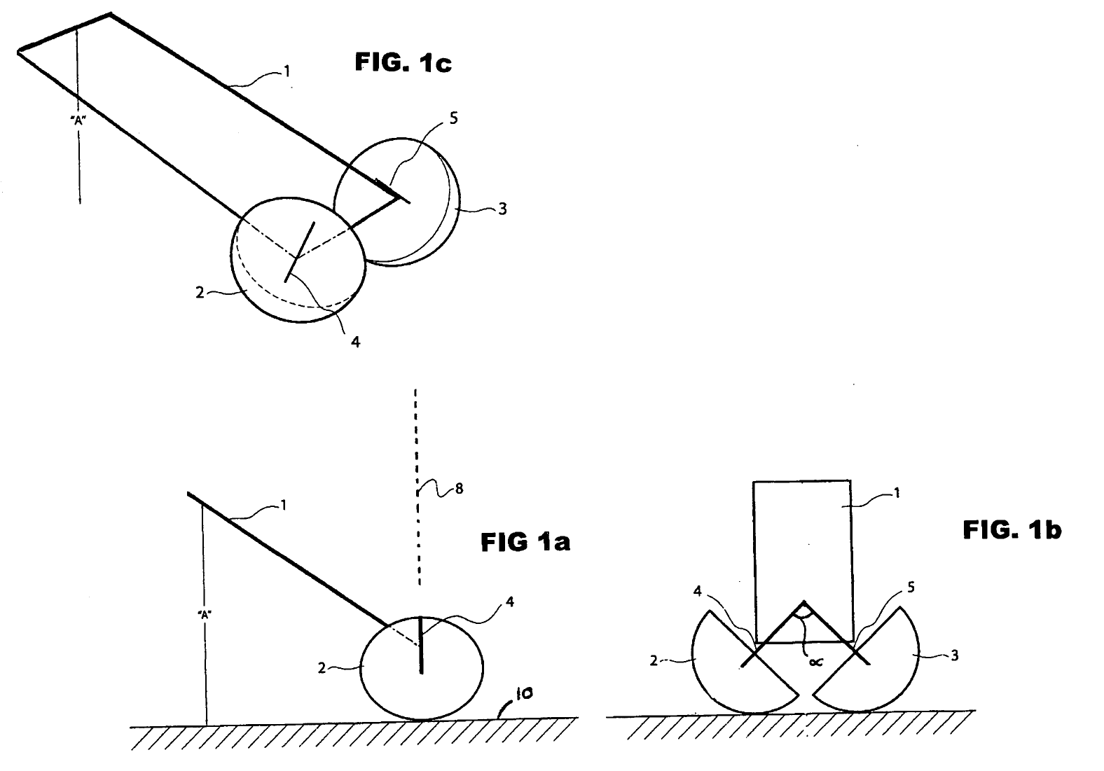

Referring to FIGS. 1a to 1c, the load-carrying apparatus shown diagrammatically there consists of a frame 1 on to which are mounted a pair of hollow hemispherical wheels 2 and 3. Wheels 2 and 3 are mounted on stub axles 4 and 5 respectively which are mounted at the lower end of frame 1 as shown in the drawings. Axles 4 and 5 are coplanar and inclined to one another at an angle α shown in FIG. 1b.

As can be seen from the drawings, when the apparatus is in the position illustrated, the frame 1 is inclined relative to the ground (horizontal surface 10) and the higher end of the frame is a distance “A” from the ground of between 50 and 150 cm.

As evident from an inspection of FIG. 1a, in this position, the axles 4 and 5 lie in a vertical plane (denoted 8) which is perpendicular to the ground 10.

In this position, the apparatus may be moved to the left or right as seen in FIG. 1a, or towards or away from the observer as seen in FIG. 1b, with rotation of wheels 2 and 3 about their respective axles 4 and 5. While the position of the apparatus is as shown in these Figures, it may thus be rolled along easily. However, if the upper end of frame 1 as shown in the drawings is either placed adjacent to ground 10 or, for example, placed vertically above the wheels (i.e., rotating frame 1 as shown in FIG. 1a clockwise until it lies in plane 8) then the two wheels are essentially splayed one with respect to another, and will not rotate easily if at all. Although the apparatus can in such a position be rotated about a vertical axis if desired, because the directions in which each wheel wishes to travel when rotating on its axle are now non-coincident, the device is essentially braked against lateral movement along the ground.

Put very simply, a two-wheeled trolley constructed on a framework of the type diagrammatically illustrated in FIGS. 1a to 1c can be easily pushed or pulled along when the upper end of frame 1 is at the proper height, A. As soon as the upper end is raised or lowered from that height, the trolley becomes progressively more difficult to push or drag along, and fairly rapidly becomes essentially braked as the top end of the frame 1 approaches the ground or moves towards a position over the wheels. Finding the correct height is quickly achieved in use of the apparatus as the user can feel how easily the apparatus is moving, and there is an automatic hardly conscious adjustment to the best position. The range of angles over which use is comfortable and the apparatus may be pushed or, more usually, pulled, will depend on the precise construction, and on the nature of the surface, with hard wheels and a hard surface narrowing the range of angles over which the movement of the apparatus is easy.

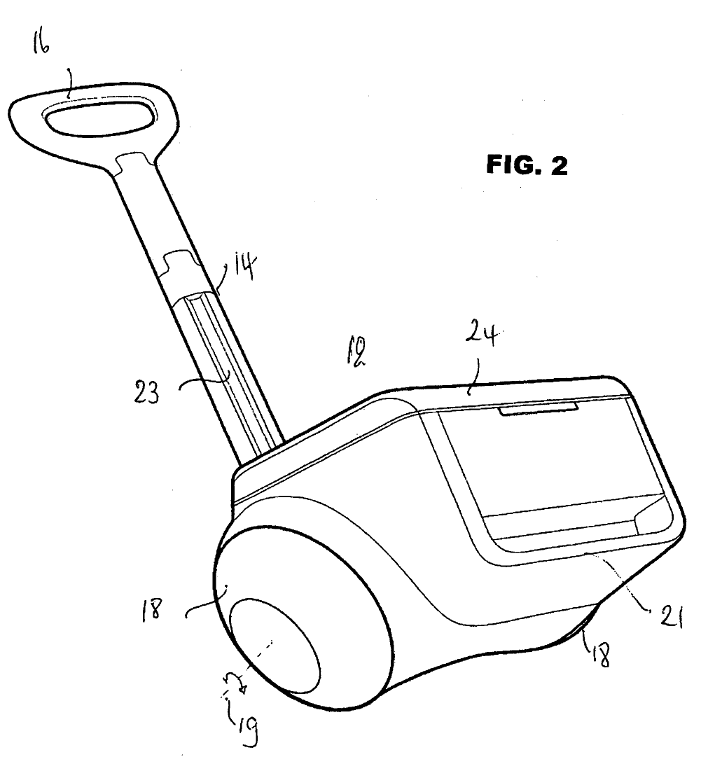

FIG. 2 shows a picnic basket constructed on these principles. It consists of a generally box-like container 12 having an extendable handle 14 fitted to one side thereof. The top of handle 14 has a hand grip 16 which is grasped by the user.

Mounted to each side of the box-like structure 12 are hollow part spherical wheels 18 which are mounted on short stub axles, e.g. as illustrated in FIG. 1b, so that they rotate around an axis 19. Axis 19 is in a vertical plane when the wheels 18 are rested on the ground and the handle grip 16 is held in the hand of the user and from 50 to 150 cm above the ground. It can be easily pulled across the ground to the desired picnic site, at which point it may be swivelled to allow the handle 14 to extend generally vertically and the front end of the box-like structure, denoted 21 in FIG. 2, to rest on the ground.

As visible in FIG. 2, the handle 14 includes a track 23 and the box-like structure has a lid 24 which is mounted by means not shown so as to be slidable in track 23. When the handle 14 is in the vertical position, the lid 24 can accordingly be raised up track 23 and clipped or latched into position at the top of the track 23 to form a picnic table. The provender is then available in box-like structure 12 and can be extracted and consumed.

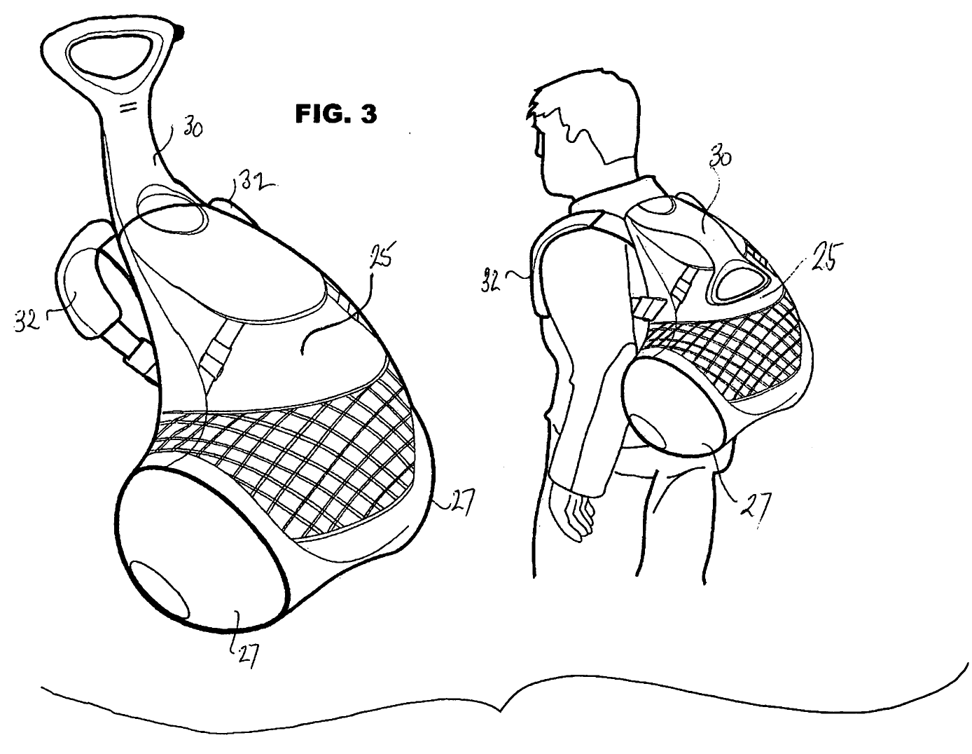

FIG. 3 shows load-carrying apparatus according to the invention configured as a backpack. On the right-hand side, this is shown on a person. The load-carrying compartment generally denoted 25 has two rotatable wheels 27 fixed to its base and rotating about axes which are at an angle to one another. A handle 30 extends from the top of the load-carrying compartment 25, and is foldable from a deployed position as shown in the left-hand portion of FIG. 3 to a folded down position when the backpack is being worn. The wearer carries the backpack by way of a pair of conventional straps 32 mounted on the main load compartment 25. Such a backpack may be carried as a backpack or, when the handle 30 is deployed, pulled along like a trolley.

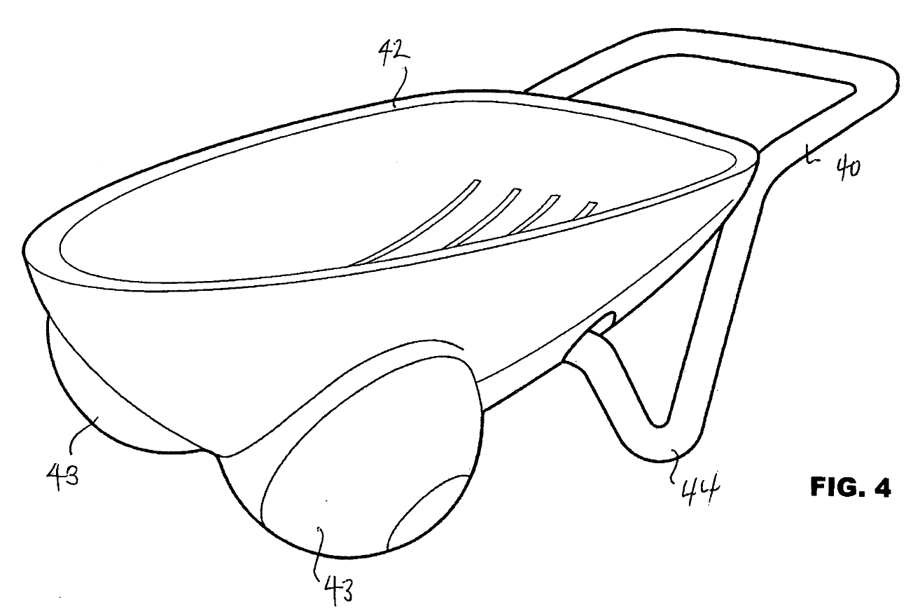

FIG. 4 shows a wheelbarrow constructed in accordance with the principles of the present invention. As can be seen, there is a tubular steel frame 40 on to which is mounted a moulded plastics load-receiving bowl 42. At the front of the frame 40 are mounted two hemispherical wheels 43 on stub axles which are so angled that they do not lie in a vertical plane when the feet of the frame 44 rest on the ground at the same level as the ground-engaging portions of wheels 43. This provides an automatic braking effect in addition to the friction between the feet 44 and the ground.

When the right-hand end of the frame 40 as shown in FIG. 4 is lifted by the user, the axles on which wheels 43 are mounted come to lie in a generally vertical plane when the barrow is being wheeled along. It can be wheeled along easily because the axles are in a vertical plane. When it is desired to tip material in the wheelbarrow on to a desired location, for example earth on to a garden bed or garden waste into a compost pit, the right-hand end of frame 40 is raised and at this point the automatic braking effect comes into play so that the front end of the barrow is then held against further movement forward and the barrow may be tipped and its contents discharged. The physical effort required to do this is reduced because the user does not have to be trying to raise the barrow at the same time as holding it back from rolling further forward.

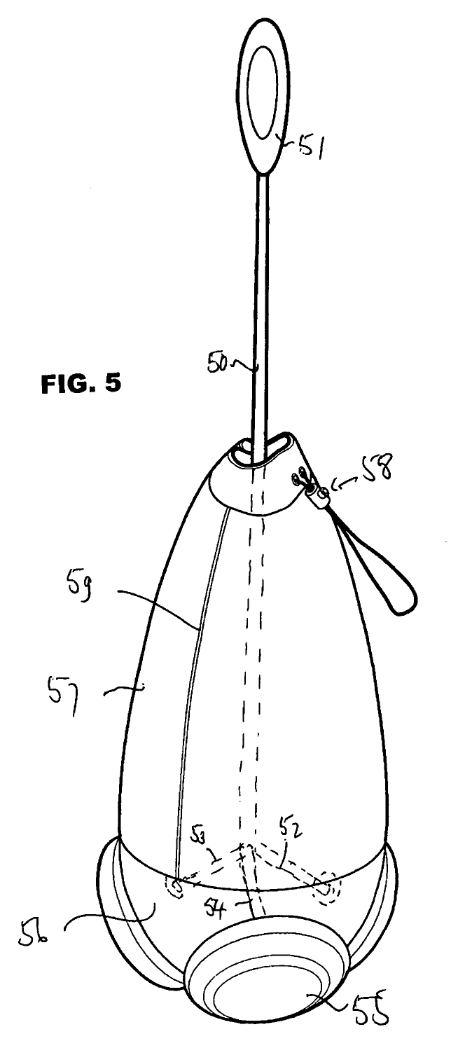

Referring now to FIG. 5, this shows a convenient shopping trolley particularly for use by the elderly who have difficulty carrying bags and who also often find it difficult to manoeuvre a “basket on wheels” of conventional construction.

As shown in FIG. 5, the shopping trolley consists of a central vertical arm 50 having a grasping handle 51, preferably swivellably mounted at its top. At the bottom of shaft 50, it branches into three stub axles 52, 53 and 54 on to the ends of each of which is fitted a substantially hemispherical ground-engaging rotatable member 55. Also attached to the bottom of arm 50 is a generally hemispherical upwardly open shell 56, to the upper edge of which is fixed a waterproof fabric cover 57 which may be drawn together when the shopping trolley is filled by the use of a drawstring and retainer 58 worked into an upper sleeve around the top periphery of cover 57. A sliding clasp fastener 59 is indicated. This is associated with an extra pocket into which things may be inserted from the outside of the trolley to keep them separate from the remainder of the contents or which, when the zip is open, may be everted so that the stowage volume available within cover 57 is materially increased.

In the position shown, the device is stable, particularly when loaded, and does not tend to roll in any direction (though it may be spun around a vertical axis if desired). When it is loaded and the user wishes to move what is inside it, he or she simply grasps handle 51 and pulls it to the side. This will lift one of the rotatable members 55 off the ground and leave the unit supported simply on the other two rotatable members 55. As the handle is moved outwards and downwards, the position is rapidly and easily achieved in which the axes of rotation of the two ground-engaging rotatable members lie in a common vertical plane, at which point the trolley may easily be moved along. The swivel mounting of handle 51 enables this action to take place automatically and without any strain on the user's hand as the trolley adopts its position with two only of the members 55 engaging the ground.

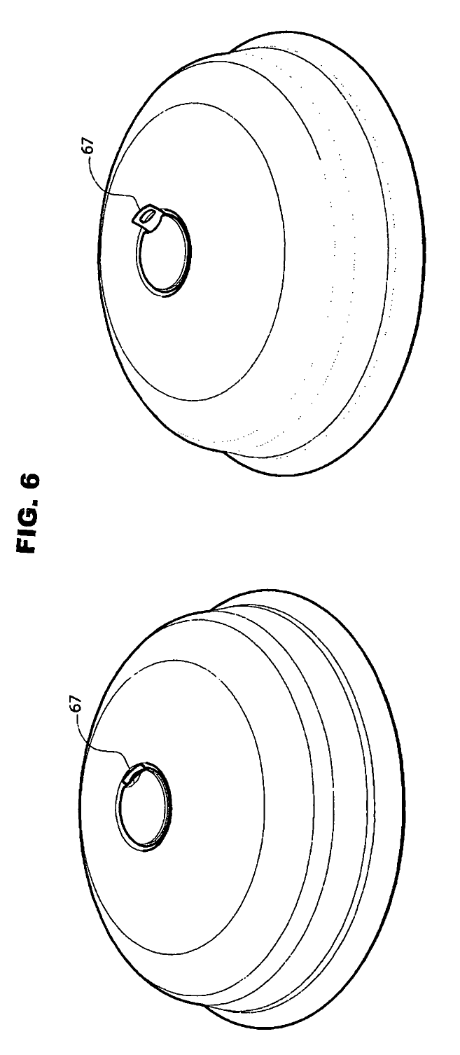

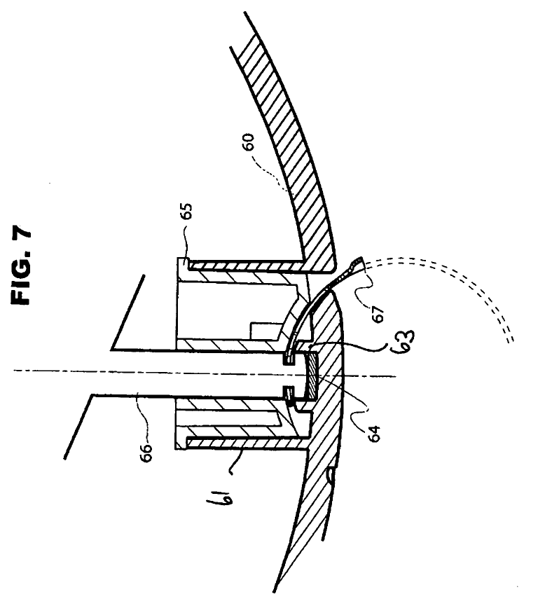

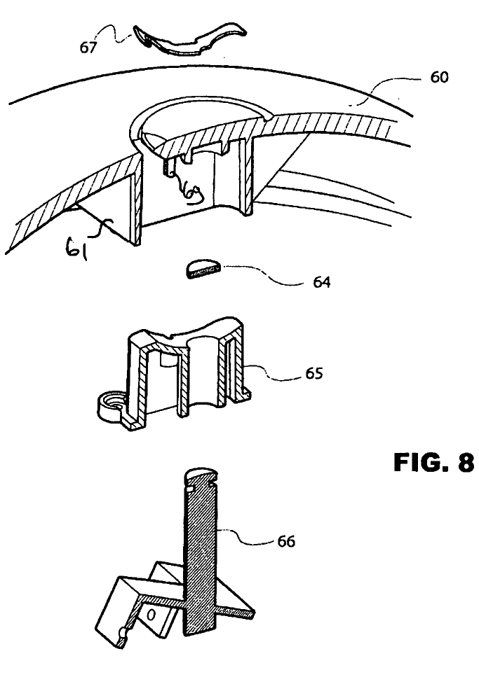

Referring now to FIGS. 6 to 9, these show a particularly preferred form of construction for the rotatable members 55 shown in FIG. 5, though this construction can be used for the rotatable members in a wide variety of embodiments of apparatus according to the present invention. As can be seen, each of these consists of a relatively rigid bowl-shaped member 60 including within it a moulded socket 61 located centrally. At the bottom of socket 61, as seen in FIG. 7, there is a seating 63 into which a disc of highly wear-resistant metal 64 is a press fit, so that once inserted, plate 64 is held captive.

The socket 61 receives a moulded lubricating bearing insert 65 made of self-lubricated engineering plastics material. It is preferably a press fit into socket 61. The centre of moulded component 65 has a straight cylindrical bore for the reception of a stub shaft 66 in which the rotatable member is to be mounted, and it is dimensioned to be neither too tight, which would reduce the ease of rotation, nor too loose, which would lead to wear and incorrect running.

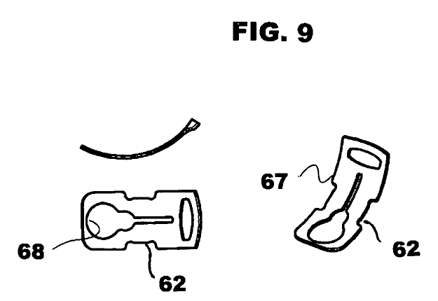

As can be seen in FIG. 7, the lower end of stub shaft 66 has a peripheral groove a little way away from its head. Its head is domed and rests against metal disc 64 in use. It is held in place within the rotatable member structure, in other words the rotatable member is held on to the stub shaft, by means of a sliding clip 67 shown in plan, side and perspective view in FIG. 9 configured with a keyhole-shaped slot 68 in it, the larger portion of which allows the passage of the head of stub shaft 66 through the clip 67. To either side of seating 63 is a resilient moulded prong 69; the prongs hold the clip in place when it is in the position shown on the right hand side of FIG. 6 by engaging in recesses 62 in the side of clip 67. The clip may be shifted from a position in which the rotatable member can be removed from the stub shaft and one where it is held captive by engaging, for example, a slotted head screwdriver or similar key in an aperture to the right hand end of the clip 67 as shown in FIG. 9.

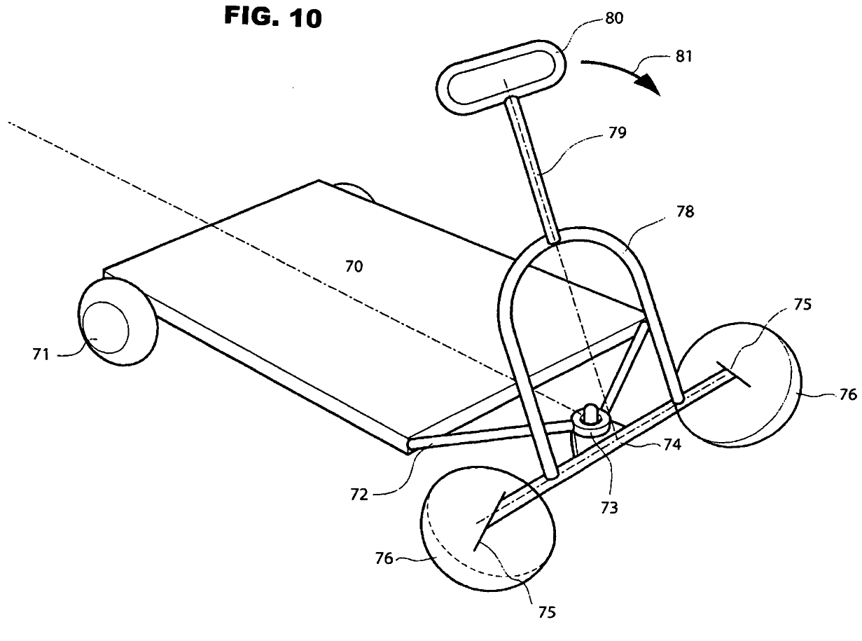

Referring now to FIG. 10, this shows a hand trolley for moving loads along, for example in a hotel transportation or industrial plant context. The trolley consists basically of a flat bed 70 supported on a pair of rear wheels 71 and having a forwardly extending support bow 72 at the end opposite wheels 71. This may be supported by a lateral support plate 73 extending from a cross beam 74 and having a vertical projection on it which passes through a vertical axis hole in support bow 72.

At each end of cross-member 74, there is an offset stub axle 75 and mounted on that is a substantially hemispherical ground-engaging rotatable member 76. Also fixed to the cross-member is a stirrup 78 connected via a shaft 79 to an actuation handle 80.

Ground-engaging members 76 are arranged as in other load-carrying apparatus according to the present invention with their respective rotational axles at an angle to one another. In the position shown, the stirrup 78 has come to rest against the front of support bow 72 (caused by the downward pressure of the flat bed 70 itself, including any load on it, on support plate 73) and, in this position, the stub axles 75 extend in a plane which is inclined to the vertical and upwardly away from the viewer in FIG. 10.

When it is desired to move the trolley, handle 80 is moved in the direction of arrow 81 and this causes the support plate 73 to rise a little, but, much more importantly, to rotate cross-member 74 until the axes of the stub axles 75 both lie in a vertical plane, at which point the trolley can easily be pulled along.

The rear wheels of the trolley 71 may be of conventional construction or they may likewise be substantially hemispherical ground-engaging members also set on a stub axle pointing downwards, but since the plane in which the axes of the two stub axles for the rear wheels 71 are located in such a case is not rotatable relative to the plane of flat bed 70, the rear wheels 71 always rotate easily.

There may be just one wheel underneath flat bed 70 if desired replacing both wheels 71. The wheels 71 may also be conventional horizontal axis wheels mounted on a bearing on a support plate so that they may rotate about a vertical axis, i.e. they may castor, so enabling the overall apparatus to be more easily maneuvered.

It is claimed:

1. A load-carrying apparatus comprising a base structure; and at least two spaced apart rotatable ground-engaging members rotatably mounted on the base structure, wherein each ground engaging member of the at least two rotatable ground-engaging members has an axis of rotation which is coplanar and at an angle to one another of at least about 10°, and wherein an angle between a plane of a surface on which the apparatus rests and a plane in which each said axis of rotation extends is variable.

2. The load-carrying apparatus according to claim 1, wherein said axis of rotation of two of said ground-engaging members intersect at a point above the surface on which the apparatus rests.

3. The load-carrying apparatus according to claim 1, wherein the rotatable ground-engaging members have an external substantially hemispherical ground-engaging surface.

4. The load-carrying apparatus according to claim 1, wherein the rotatable ground-engaging members have a ground-engaging surface of high friction material.

5. The load-carrying apparatus according to claim 1, wherein the ground-engaging members have a ground-engaging surface with a coefficient of friction which varies across the ground-engaging surface.

6. The load-carrying apparatus according to claim 1, where the angle between each of the axis of rotation about which two of the rotatable ground-engaging members rotate is between about 50° to about 100°.

7. The load-carrying apparatus according to claim 1, wherein an outer portion of the ground-engaging surface of the rotatable ground-engaging members is resilient.

8. The load-carrying apparatus according to claim 1, further comprising means for imparting a suspension effect to the rotatable ground-engaging members or a mounting thereof.

9. The load-carrying apparatus according to claim 1, wherein a load-receiving compartment is supported by the base structure.

10. The load-carrying apparatus according to claim 1, further comprising an elongate arm having at one end thereof three rotatable ground-engaging members mounted for rotation about axes thereof, each axis of said axes being at an angle of about 25° to about 80° to a direction of elongation of the elongate arm.

11. The load-carrying apparatus according to claim 10, wherein angles between said each axis of each of the rotatable ground-engaging members and the direction of elongation of the elongate arm is substantially identical.

12. The load-carrying apparatus according to claim 1, wherein the base structure is rotatably mounted on a first end of a load receiving platform or compartment and a second end of the load receiving platform or compartment is supported on at least one wheel.

13. The load-carrying apparatus according to claim 12, wherein the at least one wheel is castored.

14. Load-carrying apparatus comprising an elongate shaft, a handle mounted on a first end of the shaft, three stub axles mounted on a second end of the shaft, and three rotatable ground-engaging members, each of said ground-engaging members being mounted on one of the three stub axles, wherein the stub axles are mounted evenly around the shaft and an axis of rotation of each of said rotatable ground-engaging members intersects a longitudinal direction of the shaft at an angle of from about 25° to about 80°.

15. The load-carrying apparatus according to claim 14, further comprising a load-receiving compartment mounted around the shaft between the handle and the three stub axles.

16. A load-carrying cart comprising a flat bed for supporting a load, at least three ground-engaging wheels mounted below the flat bed, a handle for pulling the cart along, and means to enable the handle to swivel about a substantially horizontal axis, wherein at least two of the wheels are mounted spaced apart on axles rigidly fixed to the handle, and set at an angle to one another whereby axes of rotation of the at least two wheels are coplanar and the angle between a plane containing the axes of rotation and a surface of the flat bed are variable by swivelling the handle.

17. The cart according to claim 16, wherein the wheel or wheels not mounted on axles fixed with respect to the handle are mounted on castors.

18. A load-carrying apparatus comprising an elongate shaft; a handle mounted on a first end of said shaft; a container mounted on a second end of said shaft, said container including a pair of rotatable ground-engaging members having coplanar axes of rotation, wherein each of said ground-engaging members is mounted on a stub axle and each stub axle is in turn mounted at an angle α with respect to each other at the second end of said shaft or surface of said container, said angle α being between about 10° to about 100°.

19. The load-carrying apparatus according to claim 18, wherein said shaft is extendable.

20. The load-carrying apparatus according to claim 18, wherein said container has insulated side walls and a lid.

21. The load-carrying apparatus according to claim 18, wherein said shaft includes a track and said container includes a lid which is constructed and arranged to be slidingly engageable in said track and lockable in said track in a selected position.
